(19) United States
(12) Patent Application Publication
(10) Pub. No.: US 2013/0284867 A1
(43) Pub. Date: Oct. 31, 2013

(54) Gutter Hanger

(71) Applicant: Arnold Bruce Walters, Austin, TX (US)

(72) Inventor: Arnold Bruce Walters, Austin, TX (US)

(21) Appl. No.: 13/506,542

(22) Filed: Apr. 26, 2012

(51) Int. Cl. F16M 13/02

(52) U.S. Cl. 248/205.1

(57) ABSTRACT

A presented hanger exhibits a lip with a non-planar edge that mates with a trough to minimize play between the hanger lip and trough to inhibit noise and rattle.

### TECHNICAL FIELD

The present invention relates to rain and run-off collection and diversion systems and, in particular, to hangers for such systems.

### BACKGROUND OF THE INVENTION

Diversion of rain from buildings is a well-known and beneficial practice. For centuries, architects and builders have understood the benefits of diverting rain to forestall erosion, maintain structural stability, and preserve vegetation. In recent decades, a multitude of systems have been developed to divert rain from structures and homes. Typically, such systems have been placed beneath or adjacent to the roofline to allow collection and diversion of rain accumulated from across the surface area of the structure roof Such systems are sometimes called “gutter” systems.

The conventional gutter system is comprised of at least a trough, hanger and fastener. There are two principal sizes of coil used to form the gutter channels known in the art as “troughs.” For the widely found five inch-wide (5″) troughs, coil material 11 and ⅞ inches (11⅞″) wide is employed. In the Northeastern U.S., 5″ troughs are common and formed from 11 and ¾ inch (11¾″) stock. For the less widely found, but still common, six inch (6″) trough, fifteen inch (15″) coil is used.

The shape of the front of the trough contributes to structural stability and, in some systems, provides an interface for hanger and/or deflector attachment. For example, the typical trough is composed of conventional sheet metal material and has a rear wall, a bottom wall, and a curved front wall containing an Ogee-style bend with a hanger-mating fold.

During installation, a machine is employed to form the trough in lengths of up to 40 feet to fit the structure to which the system will be affixed. An installation team typically first forms trough of lengths appropriate to fit the dimensions of the structure. Hangers are then placed along the troughs approximately every two feet. Hangers are typically fitted with the trough by mating a lip of the hanger with a hanger-mating fold at the front part of the trough. With use of a fastener, the hangers are then used to affix the gutter in place on the structure.

Even though the prior art is replete with gutter hangers, hangers are typically configured with a lip having a planar surface. For instance, in U.S. Pat. No. 7,494,095 to Walker, a gutter hanger is purportedly disclosed. The Walker hanger exhibits a lip with a planar surface that is fitted into a hanger-mating fold of the trough. U.S. Pat. No. 6,209,826 to Pratt purportedly discloses a hanger and support mechanism for a fastener used with the hanger. As with Walker, the hanger disclosed in Pratt exhibits a lip with an edge for fitting into a fold along the front of a gutter. In both Walker and Pratt, however, the edge of the hanger is planar.

Despite the variety of gutter systems and hangers, gutter systems typically make noise or “rattle” when heavily loaded or subjected to substantial winds. That noise or rattle most often emanates from the interplay between the hanger and trough such as when the front wall of the trough moves, jostling the lip of the hanger in the hanger-mating fold.

What is needed, therefore, is a rain collection and diversion system that inhibits noise or rattle.

### SUMMARY OF THE INVENTION

A rattle-inhibiting hanger is presented that has a lip with a non-planar edge that mates with a trough to minimize the play between the hanger lip and the trough to inhibit noise.

### BRIEF DESCRIPTION OF THE DRAWINGS

FIG. 1 depicts a perspective view of a prior art hanger having a configuration common in the art.

FIG. 2 depicts a cross-sectional view of an enlarged area of the edge of the lip of a prior art hanger.

FIG. 3 depicts a cross-sectional view of an enlarged area of the edge of a lip of a prior art hanger and a hanger-mating fold of a trough.

FIG. 4 depicts a perspective view of a hanger configured in accordance with a preferred embodiment of the present invention.

FIG. 5 depicts a cross-sectional view of a trough and hanger assembly in accordance with a preferred embodiment of the present invention.

FIG. 6 depicts a cross-sectional view of an enlarged area of the edge of the lip of a hanger in accordance with a preferred embodiment of the present invention.

FIG. 7 depicts a cross-sectional view of an enlarged area of the lip of a hanger and the hanger-mating fold of a trough in accordance with a preferred embodiment of the present invention.

FIG. 8a depicts a cross-sectional view of an enlarged area of the edge of the lip of another embodiment of the hanger in accordance with the present invention.

FIG. 8b depicts a cross-sectional view of an enlarged area of the edge of the lip of another embodiment of the hanger in accordance with the present invention.

FIG. 8c depicts a cross-sectional view of an enlarged area of the edge of the lip of another embodiment of the hanger in accordance with the present invention.

### DETAILED DESCRIPTION OF PREFERRED EMBODIMENTS:

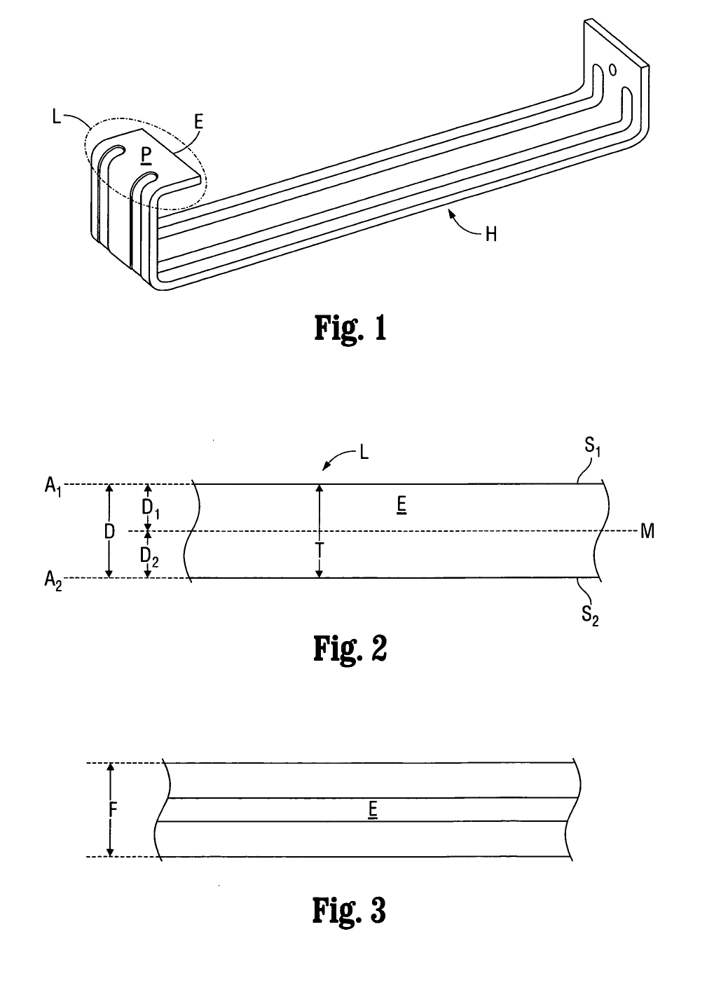

FIG. 1 depicts a perspective view of a prior art hanger H of a configuration that is common in the art. As shown within a dotted line in FIG. 1, the depicted lip L of hanger H has a planar surface P that extends to edge E. Hanger H is typically employed in gutter systems to affix trough to structures to divert or control rain runoff and water flow. When installed, lip L is typically fitted into a fold at the front of the trough by insertion or fitting of at least edge E into a hanger-mating fold of a trough to be hung.

FIG. 2 depicts a cross-sectional view of edge E of lip L of prior art hanger H. Lip L is comprised of material presenting a first surface S₁ and a second surface S₂ having a thickness measure between them of “T” as shown on FIG. 2. Imaginary midline M demarks the midline between the furthest respective excursions of surfaces S₁ and S₂ from each other along edge E which respective excursions are marked by parallel imaginary planes A₁ and A₂. D₁ is the distance from A₁ to the midline M and D₂ is the distance from A₂ to M. Because surfaces S₁ and S₂ of edge E are planar, they are therefore respectively coincident with planes A₁ and A₂ and the distance measure T of the material thickness is equal to the sum of D₁ and D₂.

FIG. 3 depicts a cross-sectional view of an enlarged area of edge E of lip L of prior art hanger H mated with a hanger-mating fold of a trough. Edge E of lip L of hanger H rests in the depicted hanger-mating fold identified as F.

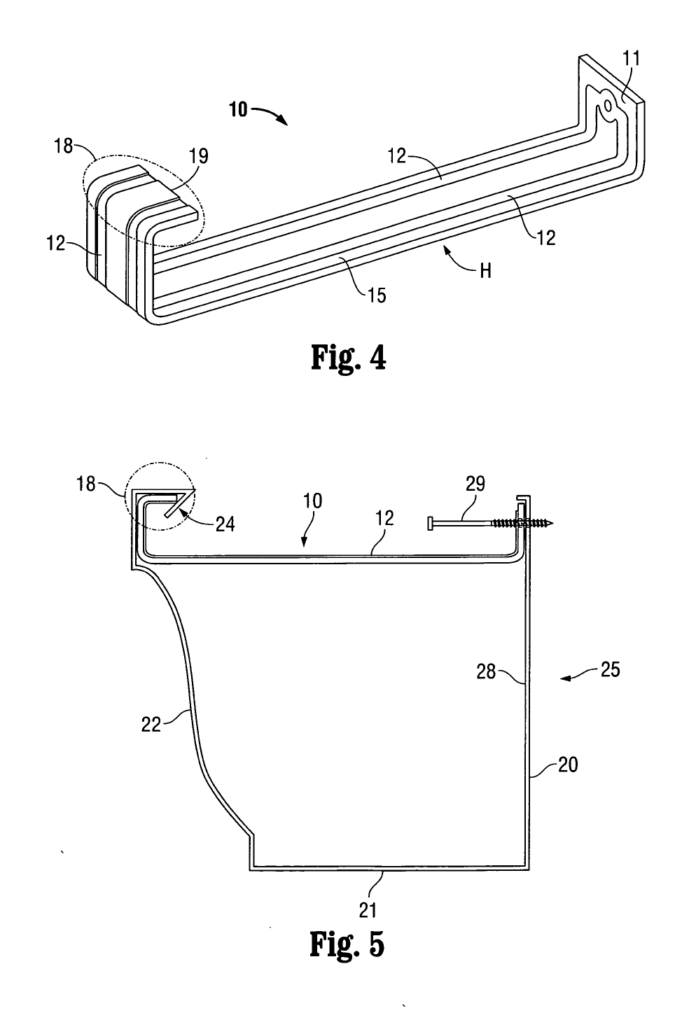

FIG. 4 depicts a perspective view of a hanger 10 configured in accordance with a preferred embodiment of the invention. Hanger 10 includes an arm 15 and raised ribs 12 that begin at back wall 11 of hanger 10 and continue along arm 15 through lip 18 which terminates at edge 19. Those of skill will appreciate that ribs 12 are merely an exemplar configuration that imposes a non-planar configuration on lip 18 and although depicted as starting at back wall 11, the non-planar configuration may start or be present anywhere on hanger 10 while understanding that the portions of lip 18 that are set or fitted within (mated) to a trough are the portions of hanger 10 that should preferably exhibit non-planarity. In particular, that means that edge area 19 of lip 18 will be now planar because upon mating with a trough, lip 19 will have at least edge 19 in cooperation with the trough. Lip 18 is configured to be received in a hanger-mating fold of a trough.

In the depicted embodiment, hanger 10 is stamped from metal, but any number of materials and formation techniques may be used to create hanger 10. For example, hanger 10 may be made of metal or plastic such as Teflon or polys, for example. If made of metal, hanger 10 can be forged, stamped, extruded, die cut or cast or other technique familiar to the trade. Metals such as copper, aluminum, and steel are exemplar materials from which hanger 10 may be devised. In each instance, various alloys may be employed such as, for example, any of the various kinds of stainless steel or copper alloys such as bronze.

FIG. 5 depicts gutter system 25, showing a cross-sectional view of trough 20 with hanger 10 and a fastener 29. As shown in FIG. 5, depicted trough 20 has a front containment wall 22 that has a hanger-mating fold 24. Trough 20 has a back wall 28. As shown, containment wall 22 need not be a planar wall but may take a variety of shapes and configurations to provide a containment function for collected liquid. Between front containment wall 22 and back wall 28, a channel is formed for water collection and diversion bottomed with a floor 21. In an embodiment having a rounded or “half-round” trough, it will be recognized that there is no distinct floor 21 and front containment wall 22 and back wall 28 will not have traditional “wall” planar areas but blend into an arcuate floor area.

In a 5-inch embodiment of trough 20 in which there is approximately 5 inches between back wall 28 and the farthest reach of a containment wall border area 26, a 5-inch hanger 10 may be employed. In a 6-inch embodiment of trough 20 in which there is approximately 6 inches between back wall 28 and the farthest reach of containment wall border area 26, a 6-inch hanger 10 may be employed.

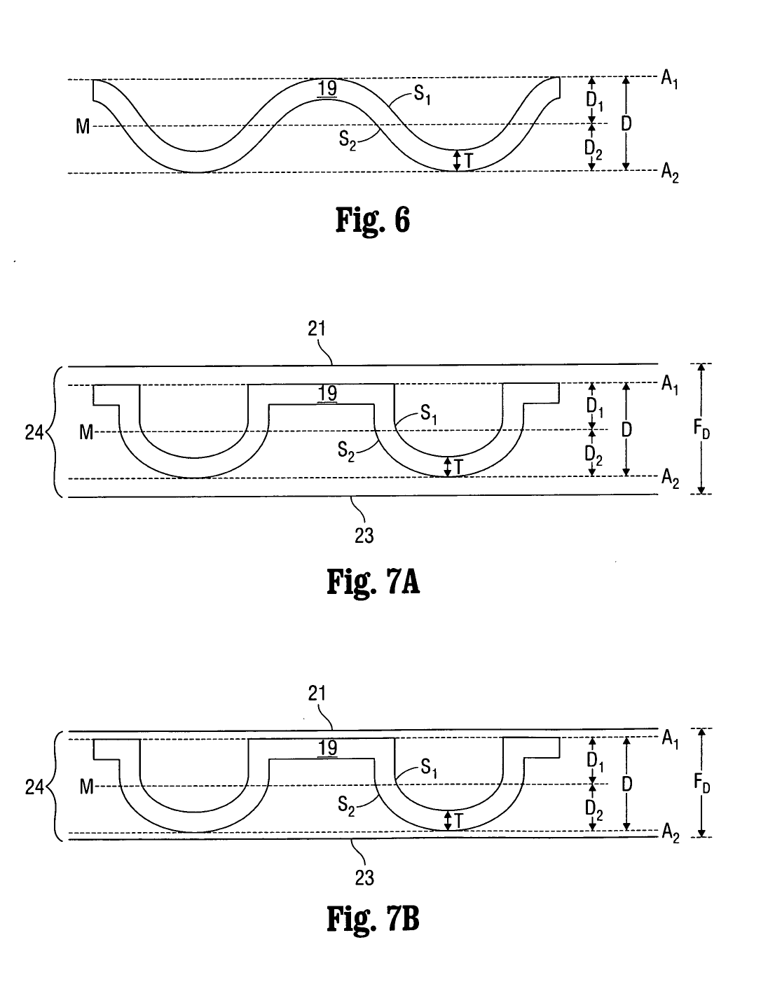

FIG. 6 depicts a cross-sectional view of edge 19 of lip 18 of hanger 10 configured in accordance with a preferred embodiment. Edge 19 may be considered that part of hanger 10 that in use will be fitted (mated) into a trough fold or confine. Edge 19 of lip 18 is comprised from a material having a first surface S₁ and a second surface S₂ with a thickness between of T. Imaginary planes A₁ and A₂ demark the furthest relative respective excursions of surfaces S₁ and S₂ from each other and imaginary midline M denotes, therefore, the middle of the total distance D between A1 and A2 with D1 being the distance from A1 to M and D2 being the distance from A2 to M. When the sum of D₁ and D₂ (i.e., D) is greater than T, edge 19 is not planar as depicted in the exemplar of FIG. 6. Preferably, D is at least twice T.

FIG. 7A depicts a cross-sectional view of an enlarged area of edge 19 of lip 18 of an exemplar hanger 10 and a hanger-mating fold 24 of trough 20 in accordance with an embodiment. Edge 19 of lip 18 of hanger 10 is mated with hanger-mating fold 24 depicted as bounded by upper fold surface 21 and lower fold surface 23. The distance from upper fold surface 21 and lower fold surface 23 is depicted as distance F_{D}. As shown, imaginary planes A₁ and A₂ mark the furthest relative respective excursions D1 and D2 of surfaces S₁ and S₂, respectively, from each other and therefore, from midline M. The distance between surfaces S₁ and S₂ is T and because the sum of D₁ and D₂ (i.e., D) is greater than T, edge 19 is non-planar. In the depicted embodiment of FIG. 7A, distance FD is slightly greater than distance D and therefore there is some play between hanger 10 and surfaces 21 and 23 of fold 24 which for purposes of this application will be called play distance (i.e., F_{D}−D=play distance). Yet, the play distance in FIG. 7A has been reduced by the non-planarity of edge 19 of hanger 10 and consequently the opportunity for rattle (i.e., the play distance) has been diminished.

As to FIG. 7B, it should be appreciated that the depiction is intended to show a preferred embodiment of hanger 10 as applied in use with a trough and in which edge 19 has been mated with fold 24 of the trough. The depiction shows some difference between F_{D} and D, however to allow distinction to be seen between plane A1 and fold surface 21 and plane A2 and fold surface 23. Those of skill will, after appreciation of this disclosure, understand that preferably, in the use of hanger 10 when properly employed, there is little or no play distance in the application and in those instances where F_{D}=D, contact between edge 19 of hanger 10 and both surfaces of fold 24 has been achieved and therefore, rattling has been substantially minimized. Thus, FIG. 7B should be appreciated as an exemplar depiction but in which F_{D} and D are not the same in order to preserve the distinctions of the view such as, for example, the visibility of hanger surface Si and upper fold surface 21.

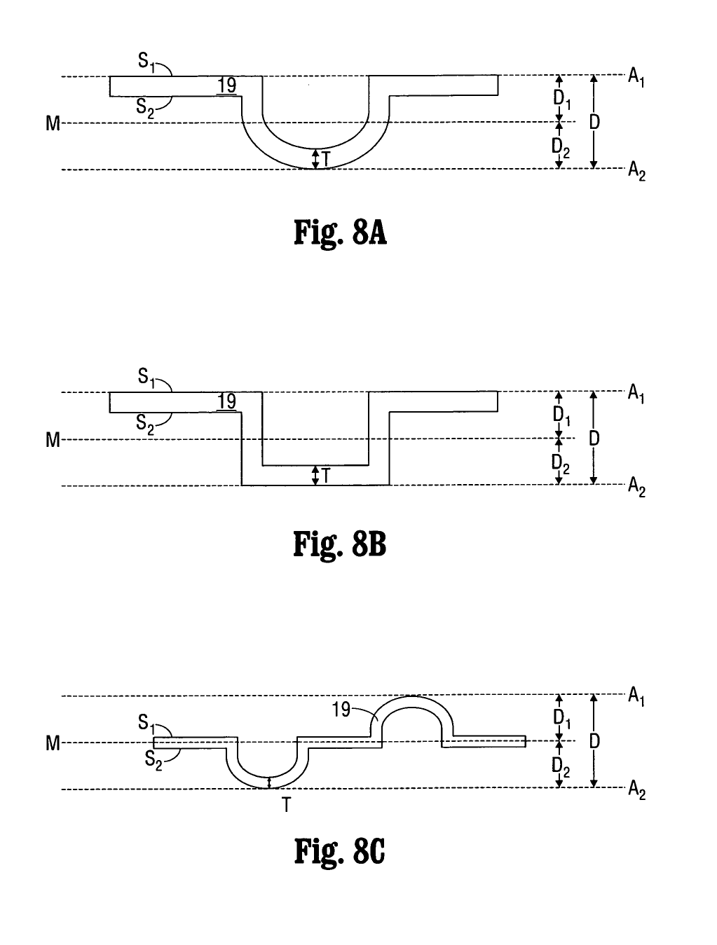

FIGS. 8a, 8b and 8c depict cross-sectional views of various exemplar configurations of edges 19 of lip 18 of exemplar hangers 10 and are included only as example embodiments and not as limitations. Each of these depicted examples depicts a non-planar edge 19 of a hanger in accordance with various respective embodiments. These are merely exemplars of the present invention and offered as examples and not limiting instances. In each of FIGS. 8a, 8b, and 8c, imaginary parallel planes A₁ and A₂ mark the furthest relative excursions of respective surfaces S₁ and S₂ from each other and therefore, midline M. In each of these examples, the thickness (T) of the material of which edge 19 is comprised is less than the sum of D₁ and D₂ (i.e., D) which mark, respectively, the distances from imaginary planes A₁ and A₂ to the midline M between those planes.

By increasing the excursion distance of surfaces S₁ and S₂ from each other at edge 19, there will be less room for play between the hanger and a trough when hanger 10 is mated with the trough.

Although the present invention has been described in detail, it will be apparent to those skilled in the art that the invention may be embodied in a variety of specific forms and that various changes, substitutions and alterations can be made without departing from the spirit and scope of the invention. The described embodiments are only illustrative and not restrictive and the scope of the invention is, therefore, indicated by the following claims.

I claim:

1. A hanger for use in a gutter system, comprising an arm with a lip for mating with a hanger-mating fold of a trough, the lip having an edge, the edge being comprised from a material having a thickness “T” denoting the shortest distance from a first surface and a second surface of the material, the edge being configured so that imaginary and parallel planes A1 and A2 are respectively coincident with maximum excursion distances of the first and second surfaces from each other so that an imaginary midline “M” denotes a midline between imaginary planes A1 and A2 with distance D1 denoting a first excursion distance from M to A1 and distance D2 denoting a second excursion distance of M to A2 so that T is less than the sum of D1 and D2.

2. The hanger of claim 1 in which the edge of the lip is ribbed.

3. The hanger of claim 1 is comprised of metal.

4. The hanger of claim 3 is comprised of extruded metal.

5. The hanger of claim 3 is comprised of stamped metal.

6. The hanger of claim 1 is comprised of steel.

7. The hanger of claim 1 is comprised of copper.

8. The hanger of claim 1 is comprised of plastic.

9. A hanger for a gutter system that presents a lip having an edge that is not planar.

10. The hanger of claim 9 in which the hanger exhibits one or more ribs along an arm into the lip and extending into the edge.

11. The hanger of claim 9 comprised of plastic.

12. The hanger of claim 9 is comprised of metal.

13. The hanger of claim 9 in which the edge presents a first surface and a second surface which are, at their closest relative disposition, a distance T apart, while at their furthest relative disposition are a distance D apart and D is at least twice T.

14. The hanger of claim 13 is comprised of metal.

15. The hanger of claim 13 comprised of plastic.

16. The hanger of claim 13 comprised of extruded metal.

17. The hanger of claim 13 comprised of stamped metal.

18. A hanger for a gutter system, the hanger having a lip and the lip having an edge that presents a first surface and a second surface which are, at their closest relative disposition, a distance T apart, while at their furthest relative disposition along the edge are a distance D apart and D is greater than T.

19. The hanger of claim 18 in which D is at least twice T.

20. The hanger of claim 18 in which D is more than 3 times T.
